(19) United States
(12) Patent Application Publication
(10) Pub. No.: US 2018/0017937 A1
(43) Pub. Date: Jan. 18, 2018

(54) REAL-TIME HOLOGRAPHIC CONTENT RECORDING PROCESS

(71) Applicant: Paul de Tharso Lazzuri Guarini, Sao Bernardo do Campo (BR)

(72) Inventor: Paul de Tharso Lazzuri Guarini, Sao Bernardo do Campo (BR)

(21) Appl. No.: 15/298,466

(22) Filed: Oct. 20, 2016

(30) Foreign Application Priority Data
Jul. 18, 2016 (BR) BR 20 2016 016592

(51) Int. Cl. G03H 1/00; H04N 21/443; H04N 21/414; H04N 21/266; G06K 9/00; H04N 21/25; H04N 21/2187; H04N 5/91; G11B 27/031; G09B 5/02; H04N 21/478; H04N 21/258

(52) U.S. Cl. CPC G03H 1/0005; H04N 21/47815; H04N 21/478; H04N 21/443; H04N 21/41407; H04N 21/266; H04N 21/25875; H04N 21/252; H04N 21/2187; H04N 5/91; G11B 27/031; G09B 5/02; G06K 9/00671; G06K 9/00355; G03H 2001/0088

(57) ABSTRACT

Description of patent comprising an architecture with digital resources associated with a holographic content store and network with visual interactive holographic interface and system integrated into the holographic content.

This descriptive report deals with the patent of an original content recording process used especially for recording holographic content in real time, generating, recording or broadcasting live, distributing, collecting and reproducing different types of holographic content on platforms compatible with mobile devices, with innovative design and featuring important technological and functional improvements, according to the most modern engineering concepts and following the standards and specifications required, with unique characteristics and fitted with basic requirements of novelty and inventive activity, thus leading to an array of real and extraordinary technical, practical and economic benefits.

### BACKGROUND OF THE INVENTION

The name Holography comes from the Greek holos (all, whole) and graphos (drawing, writing), as this is a “full” data recording method using relief and depth.

A split hologram shows the same image in different views. The integral hologram showed a kind of cube, which when broken down, generates on each piece a different angle of the same object.

The holograms have a unique feature: each of them has the information of the whole (“distributivity”). Thus, a small piece of a hologram has information on the image of the same integral hologram. It can be seen in its entirety, but from a narrow angle. A simplistic comparison can be made with a window: if we cover it, leaving a small orifice in the cover, we will allow a viewer to continue to see the landscape on the other side, however, due to the orifice, from a very narrow angle; but still, the landscape can be seen.

This “full” data-recording concept, in which each piece stores information on the whole object, is used in other areas, such as Neurology and Neuropsychology, to explain how the brain stores information or how our memory works.

Thus, holography should not be considered as just another form of three-dimensional image display, but rather as a process of encoding visual information and then (via laser) decode it, “fully” recreating the same information.

It is important to note that various forms of projection are erroneously called holographic for resulting in images that “apparently” are in the air (projections on transparent screens, films of water, smoke or oil). In fact, holography means reconstruction and completeness of an image, and not a ghostly visual impression, which is usually displayed in two dimensions.

It is important to note that, to date, there is no way of projecting images in the air without any support, whether or not holographic.

The term holography also known as hologram means “full record” or “integral record”.

As well known among the technical community, equipment that create an architecture for the production of holographic content played from mobile devices and compatible hardware are still unavailable.

The term holography, used in the context of shows, events and entertainment, is synonymous with projections in the air, which occur due to the assembly of specific holographic projects that have tensioned films or glasses and equipment such as projectors or high-gloss screens, as well as a mounting system compatible with the type of holographic content that needs to be played. There is often the need to play an existing video in conventional format on any holographic device and, in doing so, it turns out that all the holographic effect is lost due to the wrong video format, thus requiring a higher level of skilled labor for the production of videos, and further investments for live broadcasts. These difficulties associated with production of holographic content and high cost of equipment make this technological feature underused by areas of knowledge and market players. Our solution is intended to facilitate access to holographic content, creating a new and simpler image generation and data gathering process.

In this sense, some inventors have devised products that are the subject of the patent documents listed below, but have not considered the above-described details.

### SUMMARY

Description of patent comprising an architecture with digital resources associated with a holographic content store and network with visual interactive holographic interface and system integrated into the holographic content.

### STATE OF THE ART

The patent document MU 8301666-0 filed on Sep. 4, 2003 entitled filme holográfico (holographic film) teaches a technique to attach a hologram to a film made of PVC and/or similar material, so that the outcome is the creation of single, completely holographic film. This technique allows the holographic film to be used as a tool for identification and authentication when attached to objects, providing information on the legal origin of the product purchased. Thus, the holographic film serves as an ornamental product identifier, facilitating the interface between user and product, allowing easy recognition by validating the origin of found therein. It can be applied, particularly, for footwear.

The patent document PI 9711184-8 filed on Aug. 1, 1997 entitled sistema holográfico para produção de imagem grande (holographic system for creating large picture) teaches a process for producing a large holographic image of an object consisting of a plurality of image designs located on a grid, horizontally positioned next to each other and, vertically, one on top of the other. In each individual projector, a diaphragm, at least a chamber for containing an optical liquid substance, a photoelectrally-coated curved developing surface, and at least one lens surface are arranged so that an image of an object standing in front of it is attached to the image-forming surface. Each imaging surface is exposed individually with a perspective image calculated by computer and adapted to the lens system, when the elements described above are correspondingly arranged and when the exposure and reproduction projectors are suitably separated. The photoelectrically coated imaging surfaces are developed via an opening. The projectors are illuminated from behind by parallel light. Intermediate spaces are filled by the optical media or emptied and additional lens surfaces are arranged such to bundle or scatter the parallel light arriving from behind in order to shine through the image on the imaging surface and to project it into the room.

The patent document BR 20 2012 019055 4 filed on Jul. 31, 2012 entitled device for the projection of images at points of sale simulating a holographic image aims to provide a new way to interact with consumers at points of sale, enabling interactivity between the holographic simulation of an image related to the product to be marketed and the consumer, at the time he/she enters the space where the product is exposed, as for example, supermarket gondola, all sorts of counters, windows and any other marketing methods. Other types of projection equipment are already known, along with various uses, which include screens, walls, and sound output synchronized with images; screens are usually canvas suspended by wire attached to walls and other surfaces, having at least one of its faces in white, or images projected directly onto walls, which are stationary and oversized surfaces, which require large structures to accommodate computers, projector and/or TV sets, and a large space in the markets and shops , which becomes very expensive and difficult to handle, requiring several people to assemble, operate and dismantle all equipment.

After reviewing the aforementioned and state of the art documentation, it is possible to state that none of them fully features the construction characteristics of the process covered by this patent.

In view of this, over time, we have developed studies to eliminate these problems and, as a result, we have developed a process that enables the design of an architecture with digital resources associated with a holographic content store and network with visual holographic interaction interface and system integrated into the holographic content.

Therefore, one of goals of the present patent is to provide a multi-platform for the generation, distribution, collection and display of holographic digital content such as live or recorded video. The architecture consists of three parts that complement each other.

The first part is an application directed to the end user and it should be used on mobile devices to acquire and play content on compatible holographic platforms.

The second part is an application aimed at producers of content, which allows the user to record or stream videos already in holographic format.

The third part is the network of holographic content housed on the server, which communicates with other versions and allows the creation of free or paid channels, for adding videos on channels. Users of the holographic network can follow or subscribe to pay channels, getting the content from the network or store.

Both innovative concepts represent a visual interactive interface in holographic format to be used in interactive modules, and system integrated into the holographic content. The user watches a video and interacts with the system confirming that he/she saw and understood all checkpoints or enters the questions he/she had, which are then answered within the system by the producer of the content. On the other side, on an administrative module, the content producer is provided with all use indicators such as the number of people who watched the content, number of people who confirmed to have absorbed the knowledge and all questions to be answered.

These and other objectives are achieved through a process that includes an architecture that serves the client-server model, in which the client module are the applications that run on mobile devices, both versions designed for end users and content producers; the server module is the holographic content network available in the virtual store, which aims to distribute free and paid content within channels created by the users. The following is a description of the architecture details.

The first part of this process represents the architecture covered by the present invention, that is, all parts of this process, the multi-platform applications that run on smart mobile devices, such as those featuring the Android, iOS and Windows Phone operating systems.

It comprises two versions or two variations as far as the public is concerned; the end-user version, used by most people who want to watch holographic content for various reasons, and the producer-user version, used by users who want to record holographic content for online distribution.

Both versions have direct communication with the holographic content network, which serves as a holographic video store within the application, delivering videos through paid or free channels. Both versions have the account registration functionality used to access the application.

The producer version allows the user to record a video anywhere and make it compatible with the holographic format, both for storing and distributing the video, or for live broadcasting. This is done by means of pattern recognition in combination with the augmented reality technology, which, in real time, segments captured images separating the person from the background and then applies masks and filters that generate a holographic display when used with compatible hardware. Apart from recording, the producer application also features a video distribution functionality, live or not, at the store, which later will be further discussed. This version also has a system that consists of learning metrics and indicators from the availability and use of videos to and by user groups. In the producer version, this technology allows or not creating a video.

The user version provides access to different types of holographic content, either by following or by subscribing to pay channels, and allows playback on compatible hardware, with or without system interaction system.

The present process also comprises a distribution network of different types of holographic content that connects content producers with viewers through video channels. Producer-users can create free or paid channels. The videos generated by the producer application are inserted into channels. Users who access the user application can follow free channels or subscribe to pay channels. In doing so, they receive a notification whenever a new video is made available on the channel.

As the system allows holographic videos to be marketed, it is also called a virtual store, allowing the producer of holographic content to sell it through this tool.

In addition to the objectives of meetings that incorporate the telepresence technology, entertainment and any kind of holographic communication in real time or not, the use of holographic content is highly recommended because the impact of innovation retains greater attention and curiosity for the message conveyed through this technology. Therefore, this architecture features a system already linked to holographic videos, allowing users, through visual holographic interaction interface, interact with knowledge contained in the video, further expanding some terms and digitally providing feedback on the absorption of each subject and associated issues. This module is optional and is connected to the producer version, and must be configured by the time a holographic video is provided with the system.

Via the user version, the user or the person undergoing training can interact with the questions and subjects associated with each holographic video through a visual interface.

The main interaction associated with a holographic content is to assist it; however, within a learning-with-system context, the user must browse the extra content of each video and answer some key questions, providing feedback on how successful the learning process was or doubts that prevented him/her from understanding everything. This interaction happens upon detection of gestural movements towards the holography, which requires a new concept of visual holographic interaction interface.

This technology uses the camera of the mobile device to detect collision patterns between gestures and content projected in the air.

There is no information on a real time holographic content recording process featuring all the construction and functional characteristics reported above, directly or indirectly as effective as the process covered by this patent.

After completing the description and illustration of the present invention, it must be understood that it can undergo numerous modifications and variations in its embodiment, as long as such modifications and variations do not move away from the spirit and scope of the invention, such as defined in the set of claims.

What is claimed is:

1. REAL-TIME HOLOGRAPHIC CONTENT RECORDING PROCESS consisting of a multi-platform whose duty is to generate, distribute, collect and display digital holographic content such as recorded or live videos; architecture consists of three parts that complement each other; the first part is an application aimed at the end user and should be used on mobile devices to acquire and play content on compatible holographic platforms; the second part is an application aimed at producers of content, which allows the user to record or stream videos already in holographic format, and the third is a network of holographic content housed on the server, which communicates with other versions and allows the creation of free or paid channels, for adding videos to channels; users of the holographic network can follow or subscribe to channels in order to get content from the network or store.

2. REAL-TIME HOLOGRAPHIC CONTENT RECORDING PROCESS characterized by the fact that both concepts represent a visual interaction interface in holographic format, which is used in interactive modules, a system integrated into holographic content; where the user watches a video and interacts with the system confirming that he/she saw and understood all checkpoints or enters the questions he/she had, which are then answered within the system by the producer of the content; on the other side, on an administrative module, the content producer is provided with all use indicators, such as the number of people who watched the content, number of people who confirmed to have absorbed the knowledge and all questions to be answered.

3. REAL-TIME HOLOGRAPHIC CONTENT RECORDING PROCESS characterized for including an architecture that serves the client-server model, in which the client module are the applications that run on mobile devices, both versions designed for end users and content producers; the server module is the holographic content network available in the virtual store, which is intended to distribute free and paid content within channels created by the users; next, each part of the architecture is detailed; the first part of this process represents the main architecture, that is, all parts of this process, the multi-platform applications that run on smart mobile devices, such as those featuring the Android, iOS and Windows Phone operating systems.

4. REAL-TIME HOLOGRAPHIC CONTENT RECORDING PROCESS according to claim 3, characterized for comprising two versions or two variations as far as the public is concerned: the end-user version, used by most people who want to watch holographic content for various reasons, and the producer-user version, used by users who want to record holographic content for online distribution; both versions have direct communication with the holographic content network, which serves as a holographic video store within the application, delivering videos through paid or free channels; both versions feature the account registration functionality used to access the application.

5. REAL-TIME HOLOGRAPHIC CONTENT RECORDING PROCESS characterized by the fact that the producer version allows the user to record a video anywhere and make it compatible with the holographic format, both for storing and distributing the video, or for live broadcasting; this is done by means of pattern recognition in combination with the augmented reality technology, which, in real time, segments captured images separating the person from the background to then apply masks and filters that generate a holographic display when used with compatible hardware; apart from recording, the producer application also features a video distribution functionality, live or not, at the store, which later will be further discussed; this version also has a system that consists of learning metrics and indicators from the availability and use of videos to and by user groups; in the producer version, this technology allows or not creating a video.

6. REAL-TIME HOLOGRAPHIC CONTENT RECORDING PROCESS characterized in that the user version allows obtaining different types of holographic content, following or subscribing to paid channels, and playback on compatible hardware, with or without system interaction; it comprises a distribution network of different types of holographic content that connects content producers with viewers through video channels; producer-users can create free or paid channels; the videos generated by the producer application are inserted into channels; users who access the user application can follow free channels or subscribe to pay channels, such that, in doing so, they receive a notification whenever a new video is made available on the channel.

7. REAL-TIME HOLOGRAPHIC CONTENT RECORDING PROCESS characterized for allowing holographic videos to be marketed, this system is also called a virtual store, allowing the producer of holographic content to sell it through this tool; in addition to the meetings that incorporate the telepresence technology, entertainment and any kind of holographic communication in real time or not, the use of holographic content is highly recommended because the impact of innovation retains greater attention and curiosity for the message conveyed through this technology; thus, this architecture features a system already linked to holographic videos, allowing users, through visual holographic interaction interface, interact with knowledge contained in the video, further expanding some terms and digitally providing feedback on the absorption of each subject and associated issues; this module is optional and is connected to the producer version, and must be configured by the time a holographic video is provided with the system;

8. REAL-TIME HOLOGRAPHIC CONTENT RECORDING PROCESS characterized by the fact that the user or the person undergoing training can interact with the questions and subjects associated with each holographic video through a visual interface; the main interaction associated with a holographic content is to assist it; however, within a learning-with-system context, the user must browse the extra content of each video and answer some key questions, providing feedback on how successful the learning process was or doubts that prevented him/her from understanding everything; this interaction happens upon detection of gestural movements towards the holography, which requires a new concept of visual holographic interaction interface; this technology uses the camera of the mobile device to detect collision patterns between gestures and content projected in the air.
